(19) United States
(12) Patent Application Publication
(10) Pub. No.: US 2005/0021801 A1
(43) Pub. Date: Jan. 27, 2005

(54) Dynamic java push controlling apparatus and method

(75) Inventor: Seung-Hoon Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/882,353

(22) Filed: Jul. 2, 2004

(30) Foreign Application Priority Data
Jul. 3, 2003 (KR) 45024/2003

(51) Int. Cl. G06F 15/16

(52) U.S. Cl. 709/230; 709/217

(57) ABSTRACT

In a dynamic Java push controlling apparatus and method, a midlet is downloaded into a mobile terminal to perform a corresponding service. When there is a service connection request using a Java push technique, a midlet is downloaded dynamically in order to respond immediately to a corresponding service. Accordingly, users can conveniently use various services using the Java push mechanism between mobile terminals in which J2ME or other Java-based software is installed.

### BACKGROUND OF THE INVENTION

1. Field of the Invention

The present invention generally relates to a java push technique and, more particularly, to a dynamic java push controlling apparatus and method capable of dynamically downloading a required midlet and performing a corresponding service.

2. Description of the Related Art.

Java is an object oriented programming language developed by Sun Microsystems in the United States. Java language comes in many forms including: Standard Edition (J2SE), Java 2 Enterprise Edition (J2EE), and Java 2 Micro Edition (J2ME). Among them, J2ME refers to a Java platform suitable for a limited system environment including a mobile communication environment.

The J2ME may be implemented using a connected limited device configuration (CLDC) which handles a core portion related to execution of a midlet, a Java program, and a mobile information device profile (MIDP) constituting the midlet which places priority to a portion displayed on a screen. A midlet is a Java program that is executed after being downloaded. When stored in a system, a midlet can, for example, process a connection request from an external source.

Currently, the 2.0 version of MIDP is in distribution. This version includes a push registry, which performs the functions of registering the midlet and automatically operating the midlet upon receiving a corresponding request from an external source.

One example of a push registry is shown in FIG. 1. More specifically, FIG. 1 shows a mobile terminal that includes a module divided into a network interface (network connection unit), a push registry, and a midlet. When one mobile terminal of this type requests communication from another mobile terminal, the requesting terminal inquires of the push registry of the other terminal whether a midlet exists that can communicate with a midlet of the requesting terminal. In respect to the inquiry, if the push registry of the other terminal determines that a midlet exists for communication, it drives the corresponding midlet and transfers connection information to the requesting mobile terminal.

Upon receiving the connection information, the midlet attempts to establish connection based on the information. Communication may then be established between the Java midlets of the two mobile terminals. This process is called a push mechanism in MIDP 2.0.

However, such a related art Java push mechanism using the push registry fails to sufficiently utilize basic merits of Java, namely a midlet execution environment. In order to use the push mechanism, the midlet must be registered in the push registry in advance. If not, the function provided by the corresponding midlet cannot be performed. In this case, there is no method for registering the midlet which cannot be registered immediately.

### SUMMARY OF THE INVENTION

An object of the invention is to solve at least the above problems and/or disadvantages and to provide at least the advantages described hereinafter.

Another object of the present invention is to provide a dynamic Java push controlling apparatus and method which dynamically downloads a required midlet and performs a corresponding service.

To achieve at least the above objects in whole or part, the present invention provides in accordance with one embodiment a dynamic Java push controlling apparatus including: a network connecting unit for wirelessly connecting a communication between mobile terminals; a push controlling unit for requesting a midlet for communication connection from the other mobile terminal and downloading it, if the other mobile terminal has requested a push connection but the corresponding midlet does not exist in a push registry; a push registry for receiving the midlet from the push controlling unit and registering it; and a midlet unit for stoning and driving various midlets.

Preferably, if the midlet that can perform a connection in response to the connection request has been registered in the push registry, or if the midlet is downloaded and registered in the push registry, the push controlling unit hands over every authorization for the push connection over to the push registry. Preferably, the midlet unit drives the midlet under the control of the push registry.

In accordance with another embodiment, the present invention provides a Java push controlling method including: checking whether there is a push connection request from outside; checking whether a midlet, that can perform a push connection in response to the push connection request from outside, has been registered; requesting a corresponding midlet from the other party to be connected and downloading it, if the corresponding midlet has not been registered; and registering the downloaded midlet and driving it to perform the requested push connection. Preferably, the push connection request is checked through port information of a push message header part.

### BRIEF DESCRIPTION OF THE DRAWINGS

FIG. 1 illustrates the structure of a related-art Java push mechanism.

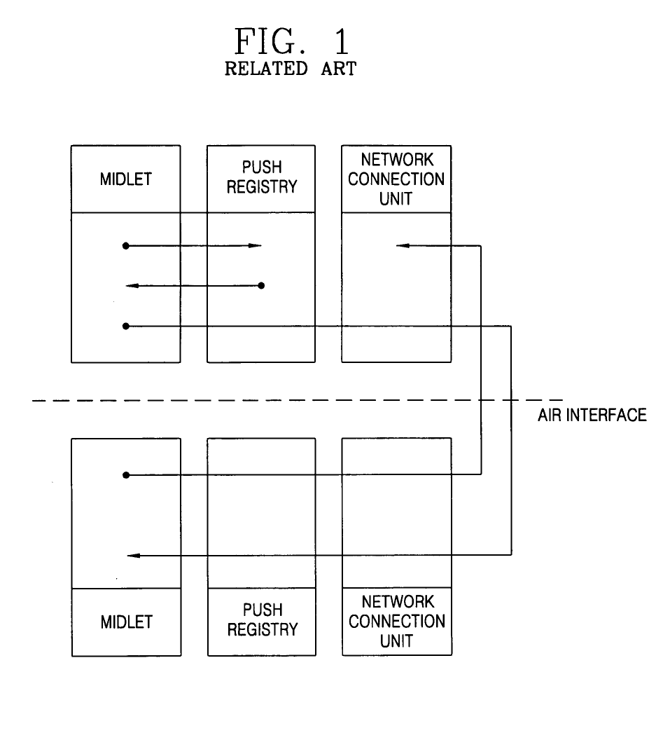

FIG. 2 illustrates the construction of a dynamic Java push controlling apparatus in accordance with a preferred embodiment of the present invention.

FIG. 3 is a flow chart showing steps included in a dynamic Java push controlling method in accordance with the preferred embodiment of the present invention.

### DETAILED DESCRIPTION OF PREFERRED EMBODIMENTS

The present invention is a system and method which allows users of a communication device, such as a mobile terminal, to communicate with each other using midlets without undergoing a certain process. This is accomplished using a push controlling unit when dynamically downloads a required midlet to perform a corresponding service. A preferred embodiment of the present invention will now be described with reference to the accompanying drawings.

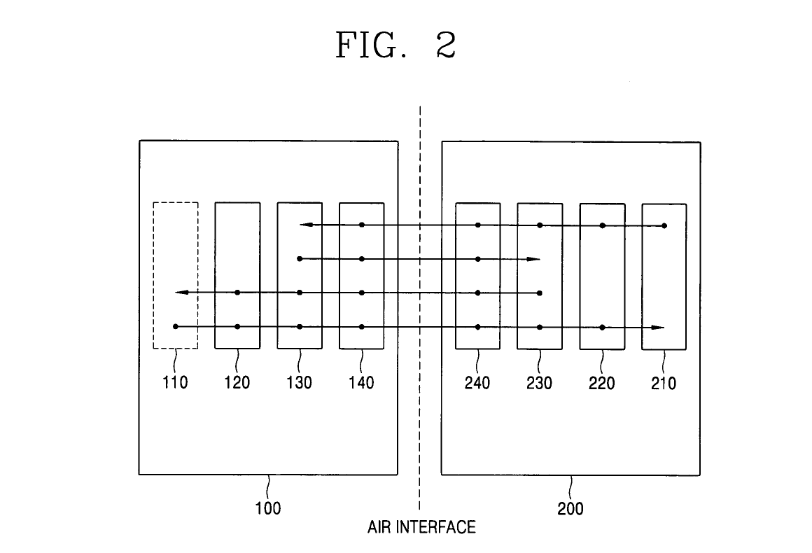

FIG. 2 illustrates an internal construction of a Java-based push controlling system in accordance with a preferred embodiment of the present invention. In this embodiment, there is no midlet for performing a connection in response to a connection request received from another mobile terminal.

More specifically, the Java push controlling system includes network interfaces 140 and 240 for wirelessly establishing communications between different mobile terminals 100 and 200. The system also includes a push controlling unit 130, a push registry 120, and a midlet unit 110. The push controlling unit requests a midlet for establishing a communication connection from a push registry 220 of the other mobile terminal and downloads it, if the other mobile terminal has requested push connection but the corresponding midlet does not exist in push registry 120. The push registry 120 receives the midlet from the push controlling unit and register. The midlet unit 110 records stores various midlets and drives a corresponding midlet under the control of the push registry.

The push controlling unit 130 receives a push connection request from the other mobile terminal 200 through the network interface 140, and checks whether a corresponding midlet, namely, a Java application program for performing the requested push connection, has been registered in the push registry 120.

If there is a corresponding midlet in the push registry 120, the push controlling unit 130 determines that an environment for performing the push connection has been constructed and hands over authorization for the push connection to the push registry.

Upon receiving the control authorization for the push connection from the push controlling unit, the push registry drives the midlet required for connection, and transfers the connection information to the midlet, thereby performing the push connection. The push registry may drive the midlet required for connection using the related-art techniques or some other technique.

If the corresponding midlet has not been registered in the push registry 120, the push controlling unit requests the corresponding midlet from the other mobile terminal 200 which has requested the push connection. Then, a push registry 230 of the other mobile terminal 200 prepares the requested midlet and transmits it to the push controlling unit 130 of the corresponding mobile terminal. Then, the push controlling unit 130 stores the downloaded midlet and registers it in the push registry 120.

When the midlet required for the push connection is completely downloaded, stored and registered as mentioned above, the push controlling unit 130 determines that an environment for performing the push connection has been constructed and hands over every authorization for the push connection to the push registry 120. Upon receiving the control authorization for the push connection, the push registry 120 drives the midlet required for connection and transfers connection-related information to the midlet, thereby performing the push connection.

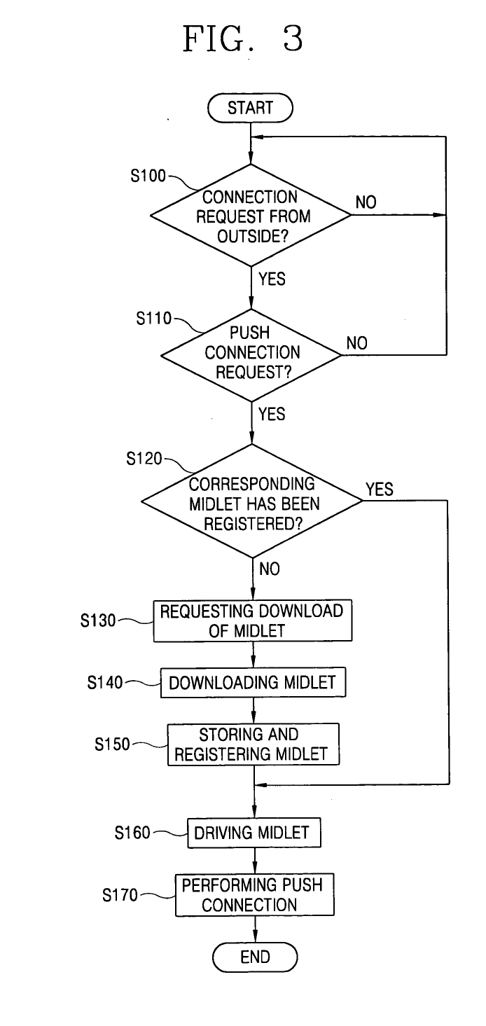

FIG. 3 is a flow chart showing steps included in a dynamic Java push controlling method in accordance with the preferred embodiment of the present invention.

In an initial step, the push controller 130 checks whether there is a connection request from an outside terminal (step S100). If a connection request exists, the push controlling unit 130 determines whether the corresponding connection request is a push connection request related to a Java push technique (Step S1 0).

For instance, if a push message as a connection request is received, since the push message bears port information in a header part, the push controlling unit can determine whether the push message is a Java message through the port information. Regarding the port information, a unique port can be allocated to an upper application program. For example, a message transferred to a specific port from a network interface (interface) can be regarded as a Java-related message. In alternative embodiments, other techniques may be used to determine whether a push message is a Java message.

If the connection request is a push connection request, the push controlling unit 130 searches the push registry 120 to check whether the corresponding midlet, namely, a Java application program for performing the requested push connection, has been registered. (Step S120).

If the corresponding midlet has not been registered in the push registry, the push controlling unit requests downloading of the corresponding midlet from the other mobile terminal 200 which has requested the push connection. (Step S130.

If the other mobile terminal 200 transmits the corresponding midlet, the push controlling unit 130 downloads it (step S140), stores the downloaded midlet in the midlet unit 110, and registers it in the push registry 120 (Step S150).

When the midlet is completely registered, the push controlling unit 130 hands over a full authorization for the push connection to the push registry 120. Then, upon receiving entire authorization for the push connection, the push registry 120 drives a midlet required for connection by controlling the midlet unit 110 (Step S160).

As the midlet for performing the requested push connection is driven in the midlet unit 110 under the control of the push registry 120, the push connection is made and the mobile terminal can communicate with the other mobile terminal (Step S170).

The midlet may include all or a portion of the programs that provide services such as short message transmission, multimedia transmission, instant message transmission, and/or others using the Java push technique. In addition to communication and/or others using the Java push technique. In addition to communication between mobile terminals, a push connection between a mobile terminal and a server can be also supported.

As so far described, the dynamic Java push controlling system and method in accordance with the present invention have at least the following advantages. For example, when there is a service connection request using a Java push technique, a midlet can be downloaded dynamically to respond immediately to a corresponding service. Accordingly, users can conveniently use various services using the Java push mechanism between mobile terminals in which the J2ME is installed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, of those skilled in the art.

1. A dynamic Java push controlling apparatus comprising:
a network connecting unit which wirelessly connects first and second mobile terminals;
push controlling unit which requests a midlet for establishing a communication connection from the second mobile terminal and then downloads the midlet if the second mobile terminal has requested a push connection but the corresponding midlet does not exist in the first mobile terminal;
a push registry which receives the midlet from the push controlling unit and registers it; and
a midlet unit which stores and drives the midlet.

2. The apparatus of claim 1, wherein the push connection request is checked through port information included a push message header part.

3. The apparatus of claim 1, wherein the corresponding midlet is a Java application program for performing a connection in response to the connection request.

4. The apparatus of claim 1, wherein if a midlet for performing a connection in response to the connection request has been registered in the push registry, the push controlling unit hands over the entire authorization for the push connection to the push registry.

5. The apparatus of claim 1, wherein the push controller downloads the midlet from the second mobile terminal which requested the push connection, stores the midlet in the midlet unit, and registers the midlet in the push registry.

6. The apparatus of claim 1, wherein the midlet unit drives the midlet under control of the push registry.

7. The apparatus of claim 1, wherein the push connection is established between the first and second mobile terminals, or between one of the terminals and a server.

8. A dynamic Java push controlling method comprising:
checking whether a push connection request has been received from a first terminal;
checking whether a midlet has been registered in a second terminal, the midlet performing a push connection in response to the push connection request;
requesting and downloading a corresponding midlet from the first terminal, if the midlet has not been registered in the second terminal;
registering and driving the downloaded midlet in the second terminal to perform the requested push connection.

9. The method of claim 8, wherein the push connection request is checked through port information of a push message header part.

10. The method of claim 8, wherein checking whether there is a push connection request comprises:
determining whether the connection request is a push connection request related to a Java push technique.

11. The method of claim 8, wherein the corresponding midlet is a Java application program that performs a connection in response to the connection request.

12. The method of claim 8, further comprising:
performing a push connection by driving the corresponding midlet if the corresponding midlet is checked to have been registered.

13. The method of claim 8, wherein the push connection is established between the first and second mobile terminals, or between one of the first and second a mobile terminals and a server.

14. A mobile terminal, comprising:
a push controlling unit which downloads a midlet into a first terminal from a second terminal, and performs a connection in response to the connection request based on the midlet.

15. The method of claim 14, wherein the Push controlling unit comprises;
a network interface which wirelessly connects to the second terminal;
a push controlling unit which requests the midlet for establishing a comminication connection with the seceond terminal and downloads it, if the second terminal has requested a push connection but the corresponding midlet does not exist in a push registriy of the first terminal;
a push registry which receives the midlet from the push controlling unit and registers it; and
midlet unit which stores and drives the midlet.

16. The apparatus of claim 15, wherein the push connection request is checked through port information included in a push message header part.

17. The apparatus of claim 15, wherein the midlet is a Java application program for performing a connection in response to the connection request.

18. The apparatus of claim 15, wherein if a midlet for performing connection in response to the connection request has been registered in the push registry, the push controlling unit hands over authorization for the push connection to the push registry.

19. The apparatus of claim 15, wherein the push controller downloads the midlet from the second terminal which has requested the push connection, stores it in the midlet unit, and registers it in the push registry.

20. The apparatus of claim 15, wherein the midlet unit drives the midlet under control of the push registry.

21. The apparatus of claim 15, wherein the push connection is made between the first and second mobile terminals, or between one of the first and second mobile terminals and a server.

22. A dynamic Java push controlling method, comprising:
downloading a midlet for performing a connection request into a first terminal from a second terminal; and
establishing a connection in response to the connection request based on the midlet.

23. The method of claim 22, wherein the midlet is downloaded from the second terminal which requested the connection.

24. The method of claim 22, wherein the connection request is a push connection request related to a Java push technique.

25. A dynamic Java push controlling method comprising:
a receiving a connection request from a first mobile terminal through a network interface;
determining whether the received connection request is a push connection request;
if the received connection request is the push connection request, checking whether a corresponding midlet has been registered in the push registry in a second mobile terminal;
if the corresponding midlet has not been registered in the push registry of the second mobile terminal, then requesting downloading of the corresponding midlet from first mobile terminal or a server;
downloading the corresponding midlet from the first mobile terminal or the server and registering the corresponding midlet; and
receiving authorization for the push connection and driving the corresponding midlet, thereby performing the push connection.

26. The method of claim 25, wherein the received connection request is determined to be a push connection request by checking port information included in a push message header part.

27. The method of claim 25, wherein the corresponding midlet is a Java application program that performs a connection in response to the connection request.
